(19) United States
(12) Patent Application Publication
(10) Pub. No.: US 2006/0117349 A1
(43) Pub. Date: Jun. 1, 2006

(54) Providing a personalized programming guide

(76) Inventor: Timothy J. Ruhl, Dacula, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 10/999,051

(22) Filed: Nov. 29, 2004

(51) Int. Cl. H04N 5/445; G06F 3/00; G06F 13/00

(52) U.S. Cl. 725/46; 725/45

(57) ABSTRACT

Provided is a personalized programming guide containing television programming information which corresponds to events scheduled in an electronic calendar, where the calendar application may reside within an electronic device in communication with a digital home communication terminal (DHCT), and where the DHCT is coupled to a subscriber television system (STS).

### TECHNICAL FIELD

The present disclosure is generally related to television programming guides and, more particularly, is related to systems and methods for providing a personalized programming guide.

### BACKGROUND

Cable television systems are now capable of providing many services in addition to analog broadcast video. In implementing enhanced programming, the home communication terminal (“HCT”), otherwise known as the settop box, has become an important computing device for accessing various video services. In addition to supporting traditional analog broadcast video functionality, digital HCTs (or “DHCTs”) now also support an increasing number of two-way digital services.

A DHCT is typically connected to a cable or satellite television network and includes hardware and software necessary to provide various services and functionality. Some of the software executed by a DHCT can be downloaded and/or updated via the cable television network. Each DHCT also typically includes a processor, communication components and memory, and is connected to a television or other display device. While many conventional DHCTs are stand-alone devices that are externally connected to a television, a DHCT and/or its functionality may be integrated into a television or other device, as will be appreciated by those of ordinary skill in the art.

Many DHCTs provide users with television program information via electronic program guides (EPGs). Some EPGs automatically scroll through television channel listings to present program information that corresponds to respective channels and time periods. Other EPGs, also known as interactive program guides (IPGs), allow a user to scroll through and/or search available program information by providing input commands via a remote control device. As many DHCT users spend substantial amounts of time watching television and browsing through IPG listings, they have become very adept and comfortable at using IPGs. However, IPGs are often inconvenient in that they do not provide information that is sufficiently tailored to the user. Therefore, there exists a need to expand IPG functionality to provide users with easy and convenient systems and methods for accessing information specifically relevant to the individual user.

Thus, a heretofore-unaddressed need exists in the industry to address the aforementioned deficiencies and inadequacies.

### BRIEF DESCRIPTION OF THE DRAWINGS

The disclosure can be better understood with reference to the following drawings. The components in the drawings are not necessarily drawn to scale, emphasis instead being placed upon clearly illustrating the principles of the present disclosure. In the drawings, like reference numerals designate corresponding parts throughout the several views.

FIG. 1 is a block diagram depicting a non-limiting example of a subscriber television system.

FIG. 2 is a block diagram depicting a non-limiting example of selected components of the DHCT depicted in FIG. 1.

FIG. 3 depicts a non-limiting example of a remote control device that may be used to provide user input to the DHCT depicted in FIG. 2.

FIG. 4 depicts a non-limiting example of a simplified block diagram illustrating the substantive information exchange between the DHCT and the local electronic device.

FIGS. 5a and 5b respectively depict non-limiting examples of monthly and daily calendar screens of an electronic calendar.

FIG. 6 depicts a non-limiting example of a personalized programming guide displayed as associated with the examples of FIGS. 5a and 5b.

FIG. 7 depicts a non-limiting example of an IPG with a link to the personalized programming guide.

FIG. 8 depicts a non-limiting example of an IPG, which incorporates the scheduled event information into the display.

FIG. 9 depicts a non-limiting example of a block diagram of a method for using a personalized programming guide in a local electronic device.

FIG. 10 depicts a non-limiting example of a block diagram of a method for using a personalized programming guide in a DHCT.

### DETAILED DESCRIPTION

Preferred embodiments of the present disclosure will be herein described in the context of a digital home communication terminal (DHCT) that is coupled to a subscriber television system (STS) in communication with a local electronic device. In accordance with one implementation, the DHCT provides a user with personalized programming information that contains television programming listings from an interactive program guide (IPG) that correspond to scheduled events in an electronic calendar application residing in a local device. The local device may be, for example, a personal computer (PC), a multi-function mobile telephone, a personal digital assistant (PDA), or other consumer electronics device. An alternative embodiment may provide for entering scheduled event information directly into an IPG.

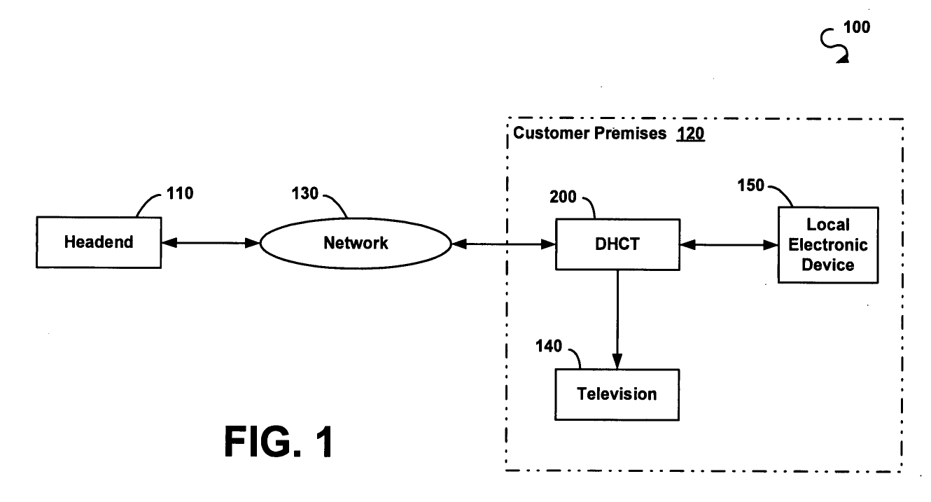

Below is a detailed description of the accompanying figures (FIGS. 1-10), which illustrate a preferred embodiment of the present disclosure. Note that all examples given herein are intended to be non-limiting, and are provided in order to help convey the scope of the disclosure. Therefore, the disclosure, which may be embodied in many different forms, should not be construed as limited to the examples set forth herein.

FIG. 1 is a block diagram depicting a non-limiting example of a subscriber television system (STS) 100. In this example, the STS 100 includes a headend 110 and a DHCT 200 that are coupled via a network 130. The DHCT 200 is typically situated at a customer premises 120 and may be a stand-alone unit or integrated into another device such as, for example, a television 140. The customer premises 120 may be a residence or place of business, among others. The DHCT 200 receives signals (video, audio and/or other data) from the headend 110 through the network 130 and provides reverse information to the headend 110 through the network 130. The network 130 may be any suitable means for communicating television services data including, for example, a cable television network or a satellite communication network, among others. The headend 110 may include one or more server devices (not shown) for providing video, audio, textual data, and/or software programming to local devices such as DHCT 200. The headend 110 and the DHCT 200 cooperate to provide a user with television services via the television 140. The television services may include, for example, broadcast television services, cable television services, premium television services, video-on-demand (VOD) services, and/or pay-per-view (PPV) services.

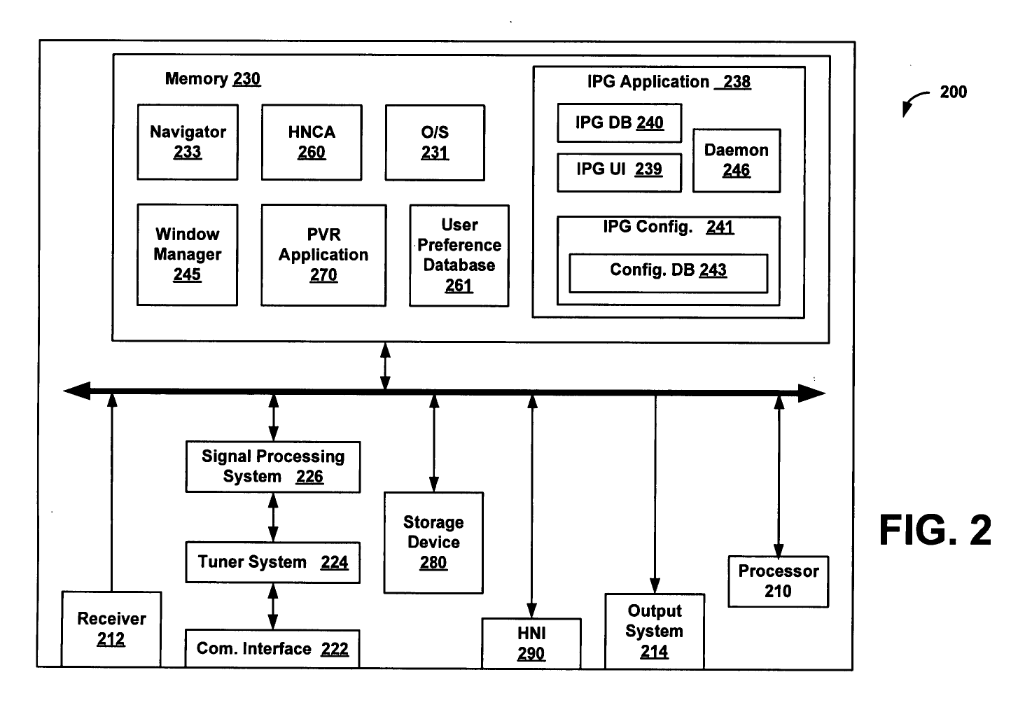

A local electronic device 150 capable of communicating with the DHCT 200 is also located at the customer premises 120. The local electronic device 150 provides one or more functionalities to a user including at least an electronic calendar and may be for example, a desktop computer, a notebook computer, a personal digital assistant (PDA) and a multi-function mobile telephone, among others. Information regarding events scheduled in the electronic calendar in the local electronic device 150 is transmitted from the local electronic device 150 to the DHCT 200 where it may be stored for comparison to the IPG database 240, as discussed below in reference to FIG. 2. The DHCT 200 subsequently provides this information to a user as part of a personalized programming guide including the television program listings corresponding to events scheduled in the electronic calendar, i.e., a “while you're busy” or “conflict” list. Alternatively, television programming in an IPG, for example, is transmitted from the DHCT 200 to the local electronic device 150, where it is compared to scheduled events in an electronic calendar to generate the personalized programming guide with the conflict list.

Examples of how a DHCT 200 may discover a local electronic device 150 include the following scenarios, among others:

1) The DHCT 200 acts as a source of IP addresses using a Dynamic Host Configuration Protocol (DHCP). This approach may involve a local electronic device 150 contacting the DHCT 200 to obtain an IP address.

2) The DHCT 200 may synchronize with a local electronic device 150 (e.g., a computer) that supports plug-and-play operation.

3) One or more local electronic devices 150 are specifically programmed to contact the DHCT 200 to register themselves with it.

4) The DHCT 200 is informed of the existence of a local electronic device 150 via information provided by user input. The DHCT 200 uses this information to contact the local electronic device 150.

Preferably, once the DHCT 200 is aware of the existence of a local electronic device 150, then the two units may communicate using a suitable communications protocol. The DHCT 200, in one embodiment, may query the local electronic device 150 about the latter's capabilities. Furthermore, the DHCT 200 may use information received from the local electronic device 150 to compose a user-interface screen for providing instructions to the local electronic device 150. In one embodiment, the DHCT 200 communicates with the local electronic device 150 using one or more residential networking standard such as, for example, Bluetooth, CAL, CEBus, Convergence, emNET, HAVi, HomePNA, HomePlug, HomeRF, Jini, LonWorks, UPnP, 802.11A, 802.11B, 802.11G, 802.15.3 and VESA, among others.

FIG. 2 is a block diagram illustrating a non-limiting example of selected components of a DHCT 200. The DHCT 200 comprises a communications interface 222 for receiving video, audio and other data from the headend 110 (FIG. 1), and for providing reverse information to the headend 110. The DHCT 200 further includes at least one processor 210 for controlling operations of the DHCT 200, an output system 214 for driving a display device (e.g., a television 140), and a tuner system 224. The tuner system 224 tunes to a particular television service to be displayed via the television 140 and sends and receives various types of data to/from the headend 110. The tuner system 224 includes in one implementation, an out-of-band tuner for bi-directional quadrature phase shift keying (QPSK) data communication and a quadrature amplitude modulation (QAM) tuner for receiving television signals. A receiver 212 receives user inputs that are provided via an input device such as, for example, a transmitter with buttons or keys located on the exterior of the terminal, a hand-held remote control device, or a keyboard.

A home network communications application (HNCA) 260 communicates with a local electronic device 150 via a home network interface (HNI) 290. The HNI 290 acts as an interface for transmitting and/or receiving data to/from a local electronic device 150. The HNI 290 may comprise, for example, a USB (Universal Serial Bus) connector, an Ethernet port, an IEEE-1394 connection, a serial port, a parallel port, a wireless radio frequency (RF) interface, a telephone line interface, a power line interface, a coaxial cable interface, and/or an infrared (IR) interface, among others. In one possible implementation, the HNI 290 may be coupled to a local electronic device 150 via an Ethernet hub. A driver for the HNI 290 may be included in the operating system (O/S) 231 or may otherwise be stored in memory 230.

Memory 230, which may include volatile and/or non-volatile memory, stores one or more programmed software applications, herein referred to as applications, which contain instructions that may be executed by the processor 210 under the auspices of the O/S 231. Data required as input by an application is stored in memory 230 and read by processor 210 from memory 230 as needed during the course of the application's execution. Input data for an application may be data stored in memory 230 by a secondary application or other source, either internal or external to the DHCT 200, or may be data that was created with the application at the time it was generated as a software application program. Data transmitted by the headend 110 may be received via the communications interface 222, whereas user input may be received from an input device via receiver 212. Data generated by an application is stored in memory 230 by processor 210 during the course of the application's execution. Availability, location and amount of data generated by one application for consumption by another application is communicated by messages through the services of the O/S 231.

The IPG application 238 displays a program guide to the user and populates the guide with information about television functionalities. The IPG 238 includes an IPG user interface module 239 component that creates an IPG for presentation to the user. The IPG user interface module 239 accesses configuration settings stored in an IPG configuration module 241 to implement an appropriate configuration for the IPG 238. The IPG 238 configuration module 241 includes a configuration database 243 for storing a plurality of IPG configurations. The IPG user interface module 239 populates the IPG 238 with information contained in an IPG database 240. The IPG database 240 contains data files corresponding to services that are available via the DHCT 200. This data may be compared to scheduled event information received from the electronic calendar application of the local device 150.

Based on the configuration information stored in the IPG configuration module 241, the IPG user interface module 239 utilizes the window manager 245 and other graphics utilities provided by the O/S 231 to render an IPG on the television 140. The window manager 245, which may also be part of the O/S 231, contains functionality for allocating screen areas and managing screen use among multiple applications. The O/S 231 provides primitives to the IPG user interface module 239 in order to help render images on the television 140 (FIG. 1).

As a window is generated on a display device, the IPG user interface 239 registers with the window manager 245 in order to receive particular user input commands that may be required for selecting options provided by the newly-created window. The IPG 238 also contains a daemon application 246 that forwards IPG data received from the headend 110 or the local electronic device 150 to the IPG database 240. Such IPG data may include information about services and functionalities that are provided by the DHCT 200 and may be compared with the scheduled event information stored in the electronic calendar application of the local electronic device 150.

If a user selects a functionality instance corresponding to the storage of television programming, then the HNCA 260 may request that such television programming be stored in the storage device 280. When the DHCT 200 receives a video stream corresponding to the requested television programming, then the personal video recorder (PVR) application 270, in cooperation with an appropriate device driver, may effect the storage of the video stream in the storage device 280. The PVR application 270, in cooperation with an appropriate device driver, may effect the storage of a video stream in a storage device 280. The PVR application 270 may also effect the retrieval and presentation of a video stream including the provision of trick mode functionality such as fast forward, rewind, and pause. Under the methods and systems herein, the PVR application 270 may also effect the storage of a video stream in the storage device 280 during a scheduled event stored in an electronic calendar in the local electronic device 150.

The IPG application 238, the HNCA 260, the PVR application 270, the electronic calendar application, and all other applications executed by the resources of the DHCT 200 and the local electronic device 150 comprise executable instructions for implementing logical functions. The applications can be embodied in any computer-readable medium for use by or in connection with an instruction execution system. The instruction execution system may be, for example, a computer-based system, a processor-containing system, or any other system capable of executing instructions. In the context of this document, a “computer-readable medium” can be any means that can contain, store, communicate, propagate, or transport the program for use by or in connection with the instruction execution system, apparatus, or device. The computer-readable medium can be, for example, but is not limited to, an electronic, solid-state, magnetic, optical, electromagnetic, infrared, or semiconductor system, apparatus, device, or propagation medium, either internal to the DHCT 200 or externally connected to the DHCT 200 via one or more communication ports or network interfaces. More specific examples (a non-exhaustive list) of the computer-readable medium would include the following: an electrical connection (electronic) having one or more wires, a portable computer diskette (magnetic), a hard drive storage device (magnetic), a random access memory (RAM) (solid-state device), a read-only memory (ROM) (solid-state device), an erasable programmable read-only memory (EPROM or Flash memory) (multiple devices), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

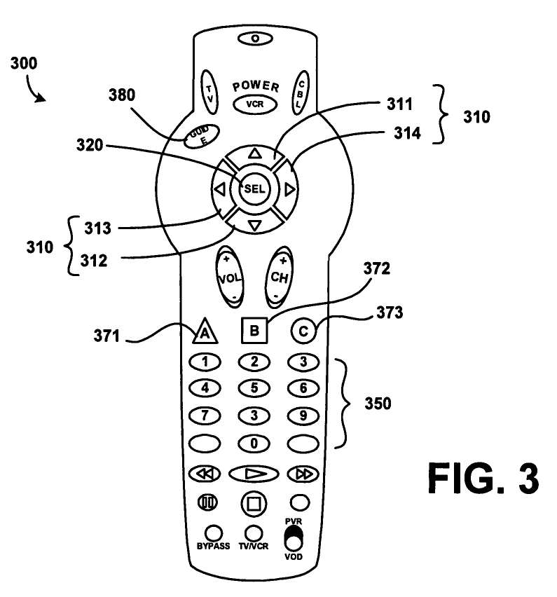

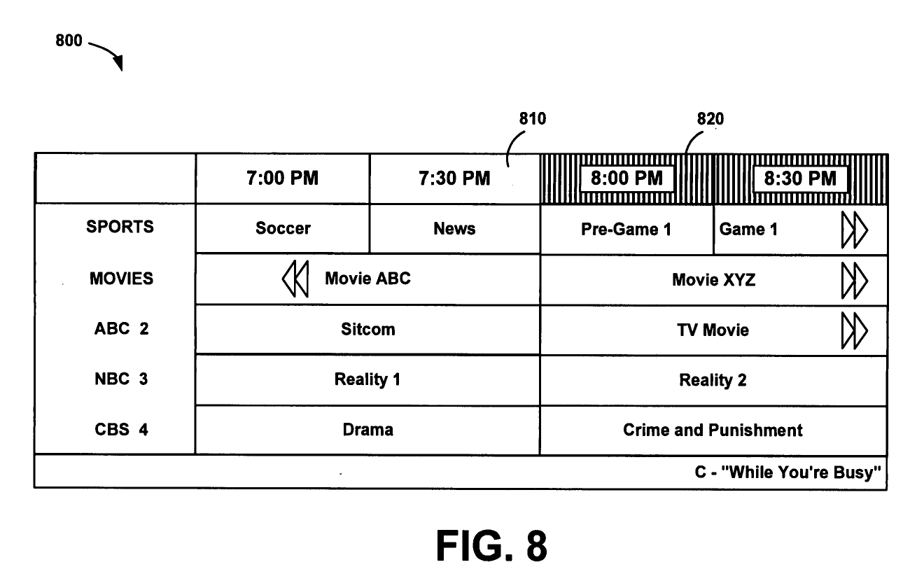

FIG. 3 depicts a non-limiting example of a remote control device 300 that may be used to provide user input to the DHCT 200. The remote control device 300 described herein is merely illustrative and should not be construed as implying any limitations upon the scope of the present disclosure. Four arrow keys 310 are provided including an up arrow key 311, a down arrow key 312, a left arrow key 313, and a right arrow key 314. The arrow keys 310 can be used to scroll through on-screen options and/or to highlight an on-screen option, whereas the select key 320 may be used to select a currently highlighted option. The guide key 380 may be used to access a television program guide such as, for example, IPG screen 800 (FIG. 8). The function of the “A” key 371, the “B” key 372, and the “C” key 373 varies depending on the screen being presented to a user at the time of a key's activation. In one embodiment, the “A” key 371 can be used to access a browse-by list for requesting an IPG screen that contains a subset of service instances falling under a user selected browse-by category such as, for example, comedy, drama, action/adventure, sports, etc.; the “B” key 372 can be used to request an IPG screen containing service listings for a user selected date; and the “C” key 373 can be used to generate a personalized programming guide corresponding to scheduled events in an electronic calendar.

In an alternative embodiment of this disclosure, different and/or additional systems and methods of providing user input may be used including, for example, a remote control device having different keys and/or key layouts, a keyboard device, a mouse, a voice activated input system, a touch-screen display, etc. The disclosure described herein is not limited by the type of device used to provide user input.

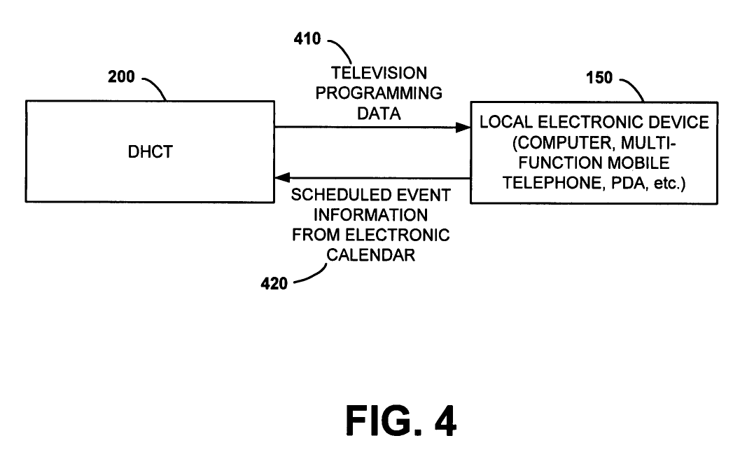

Reference is briefly made to FIG. 4, which illustrates a non-limiting example of a simplified block diagram of the substantive information exchange between the DHCT 200 and the local electronic device 150. Whether the personalized programming guide is accessed through the DHCT 200 and viewed on a television or through the local electronic device 150, the substantive information exchanged between the components is essentially the same. For example, in one embodiment, the local electronic device 150 receives the television programming data 410 of an IPG and displays the portion corresponding to a scheduled event. Alternatively, the user may elect to view the personal programming guide through the DHCT 200 whereby the DHCT 200 receives the scheduled event information 420 from the local electronic device 150. Additionally, the local electronic device may communicate command functions, such as RECORD, for scheduling within the DHCT 200. As noted above, communications between the DHCT 200 and the local electronic device 150 can be any combination of wired and wireless communication technology.

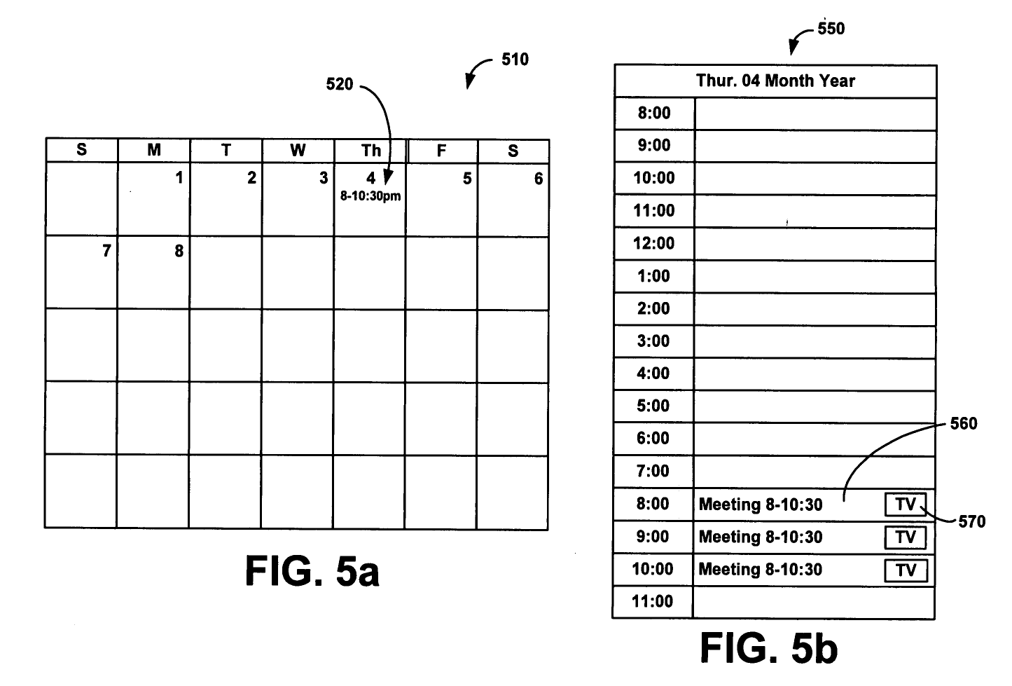

Reference is now made to FIGS. 5a and 5b, which respectively illustrate non-limiting examples of monthly and daily calendar displays of an electronic calendar. Although the electronic calendar of some embodiments is an application in the local electronic device 150, alternative embodiments may utilize an electronic calendar application in the DHCT 200. By way of example, the monthly calendar display 510 is shown having an event scheduled 520 on Thursday the fourth from 8:00 PM until 10:30 PM. As is common in electronic calendars, the user may view a daily schedule 550 by selecting the specific day 520 using a cursor, stylus or other graphical user interface methods (not shown). Continuing with the above example, the daily calendar display of FIG. 5b indicates an event scheduled in the timeslots corresponding to the event time 560. Also displayed within each of the event associated timeslots is a virtual button 570 to provide the user with a link to access the television programming information corresponding to that timeslot 560. To access the television programming information for a particular timeslot during the scheduled event, the user actuates the virtual button 570 in that displayed timeslot 560.

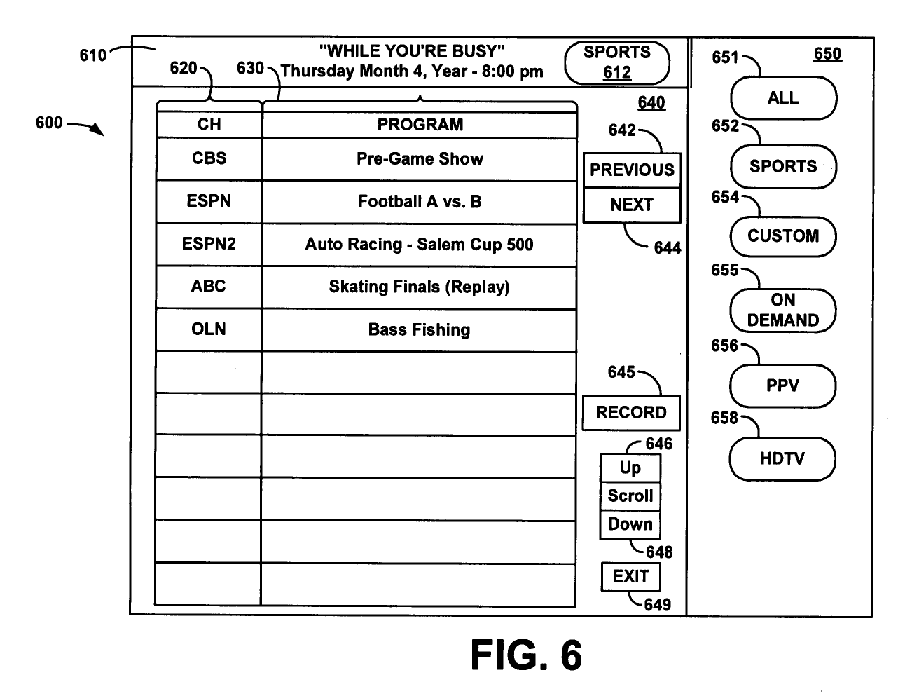

Reference is now made to FIG. 6, which illustrates a non-limiting example of a personalized programming guide displayed corresponding to the example of FIGS. 5a and 5b. The personalized programming guide 600 corresponding to the exemplary scheduled event of the previous example includes an identification box 610 for communicating at least the date and time of the displayed programming and that the programming corresponds to the time of a scheduled event in the exemplary language “WHILE YOU'RE BUSY”. Additionally, the identification box 610 may contain information pertaining to any program content or program format related filtering in effect. For example, the SPORTS display 612 in the identification box indicates that the television programming displayed is sports related.

Within the personalized programming guide 600 are columns for the channel designation 620 and the program description 630. Although not illustrated, the personalized programming guide 600 could also include numerical channel designators, program descriptions, start and stop times, and content ratings, among others. The personalized programming guide 600 also includes a section for providing additional functions 640. For example, a user can view the television programming for the next “WHILE YOU'RE BUSY” timeslot by selecting the virtual NEXT button 644. Similarly, a user may view the television programming for previous “WHILE YOU'RE BUSY” timeslot by selecting the virtual PREVIOUS button 642. In the case where the personalized programming guide 600 does not display all of the television programming during a specific timeslot, the user may use the scroll UP 646 and scroll DOWN 648 virtual buttons to view the remaining television programming listings. Additionally, a viewer may select a program to be recorded by first selecting the program and then selecting the virtual RECORD button 645. Where the electronic calendar application resides in the local electronic device 150, the RECORD function is communicated to the DHCT 200 for scheduling. When the user is finished viewing the personalized programming guide 600, the virtual EXIT button 649 may be selected and the display will return to the calendar or other application.

A filter section 650 for filtering the displayed television programming is also included in the personalized programming guide 600. The filtering can be based on genre, such as SPORTS 652, or program delivery or presentation format, such as ON DEMAND 655, PPV 656 or HDTV 658, among others. Additionally, the user can program a CUSTOM 654 filter for selecting listings based on specific series, subjects, actors, and directors, among others.

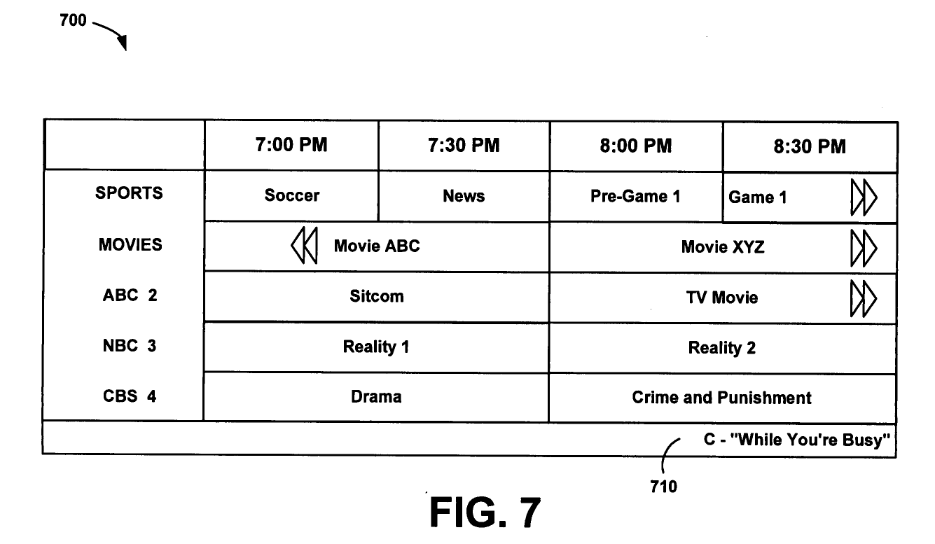

Reference is now made to FIG. 7, which illustrates a non-limiting example of an IPG with a link to the personalized programming guide 600. In the case where a user wants to access the personalized programming guide 600 directly from an IPG 700, a link 710 may be provided as either a virtual button or, for example, a function assigned to one of the keys on a remote control unit, such as the “C” key 373. Additionally, the personalized programming guide 600 can be accessed through a service portal on high level menu (not shown) within the DHCT.

Reference is now made to FIG. 8, which illustrates a non-limiting example of an IPG which incorporates the scheduled event information into the display. The IPG 800 includes the time columns for times in which there are no events scheduled 810 and displays the time columns during which an event is scheduled as, for example, a bold border 820. In addition to the use of a distinctive border, the columns corresponding to the times during which an event is scheduled can be displayed in the IPG in a different color, shade, font, or some combination of these, among others. Further, television programming events already scheduled to be recorded can be displayed in additional ways to so indicate.

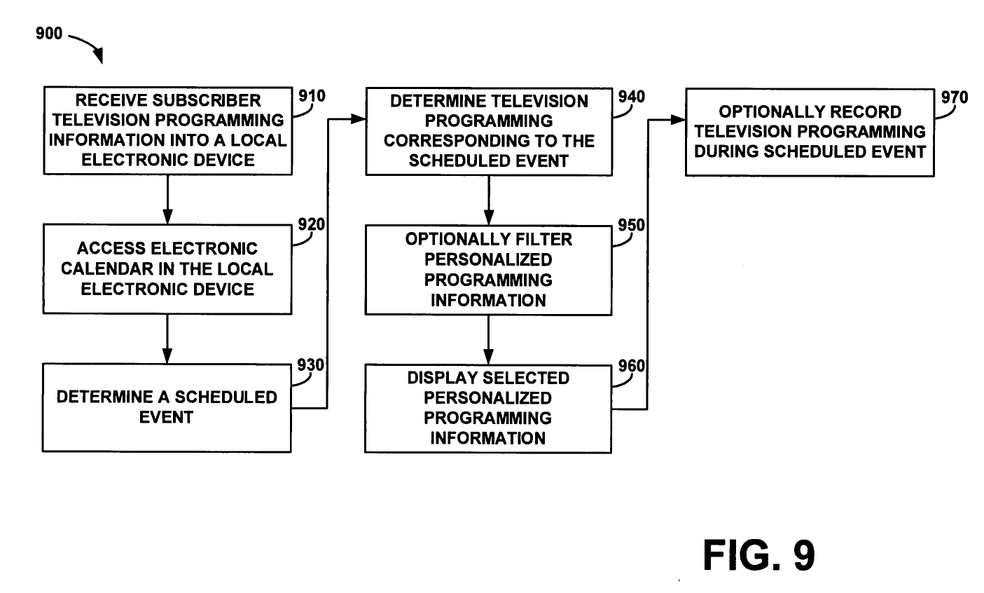

Reference is now made to FIG. 9, which illustrates a non-limiting example of a block diagram of a method of an embodiment as disclosed herein. In accordance with the method 900, the local electronic device receives subscriber television programming information from the DHCT 910. An electronic calendar application in the local electronic device is accessed 920 to determine the date and time of a scheduled event 930. Although this method is only presented in the context of a single scheduled event, one of ordinary skill in the art knows, or will know, that the method of this and all embodiments herein are applicable to multiple events scheduled at any combination of times and dates. The subscriber television programming is compared to the date and time of the scheduled event to produce personalized programming information corresponding to the date and time the user has a scheduled event 940.

In the case where the user has preferences regarding program content or program format, the personalized programming information can be optionally filtered based on numerous criteria 950. For example, the programming can be filtered by genre, such as sports, drama, comedy, and action. Other available filter criteria include, for example, program format, such as movies, series, documentaries, HDTV, PPV, specific channels or any combination of these. These filter options can be programmed, for example, as individual virtual buttons or in combination under user customized buttons.

After any optional filtering is performed, the personalized programming information is displayed 960. In addition to providing the user with a listing of the television programs that will be broadcast during the time the user is at the scheduled event, the user may optionally establish program sequence to record a program listed in the personalized programming information 970. The recording function can be accomplished, for example, through a personal video recorder/digital video recorder (PVR/DVR) device or through a combination of a recording device and an associated interface to the device, such as, for example, an IR blaster.

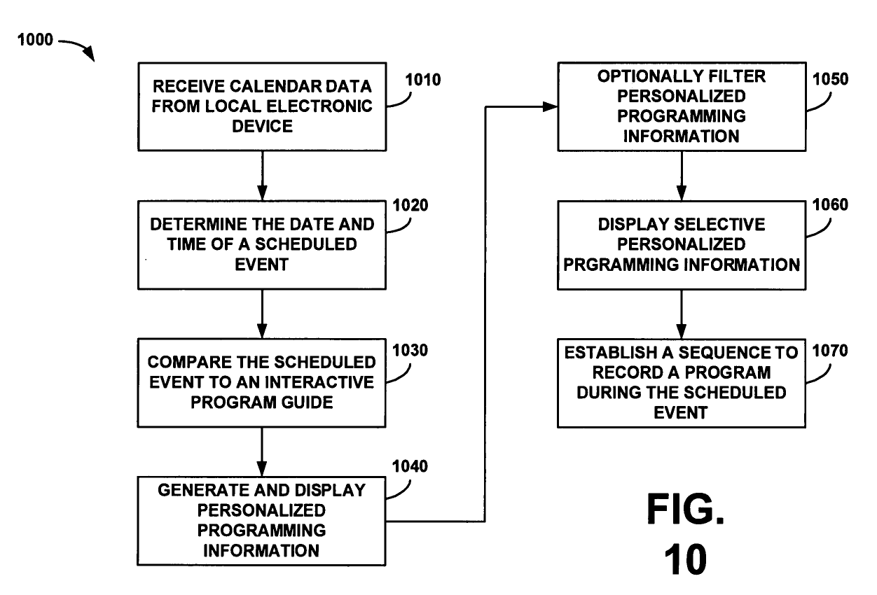

Reference is now made to FIG. 10, which illustrates a non-limiting example of a block diagram of a method of an embodiment as disclosed herein. In accordance with the method 1000, a DHCT receives calendar data from a local electronic device 1010. The calendar data is utilized to determine the date and time of a scheduled event 1020. As discussed above, one of ordinary skill in the art knows, or will know, that the method of this and all embodiments herein are applicable to multiple events scheduled at any combination of times and dates.

The date and time of the scheduled event is compared to an IPG to determine which television programming is scheduled for broadcast while the user is occupied at the scheduled event 1030. The resulting television programming information is generated and displayed as personalized programming information 1040. The user also has the option of filtering the personalized programming information 1050. As discussed above, for example, the programming can be filtered by genre, such as sports, drama, comedy, and action. Other available filter criteria include, for example, program format, such as movies, series, documentaries, HDTV, PPV, specific channels or any combination of these. These filter options can be programmed, for example, as individual virtual buttons or in combination under user customized buttons. The selective information resulting from any filtering is then displayed 1060.

After any optional filtering is performed 1050 and the personalized programming information is displayed 1060, the user may optionally establish program sequence to record a program listed in the personalized programming information 1070. The recording function can be accomplished, for example, through the PVR/DVR device or through a combination of a recording device and an associated interface to the device, such as, for example, an IR blaster.

Any blocks or steps shown in FIGS. 9 and 10 should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

The functionality provided by the method illustrated in FIGS. 9 and 10, can also be implemented through hardware (e.g., an application specific integrated circuit (ASIC) and supporting circuitry). Each implementation may have a perceived advantage, however.

For example, hardware enjoys a speed and, arguably, a reliability advantage over software because hardware testing and verification methods are currently more advanced than software verification methods. On the other hand, software can be less expensive than customized hardware and offers greater flexibility in adding or modifying product features.

The functionality provided by the methods illustrated in FIGS. 9 and 10, can be embodied in any computer-readable medium for use by or in connection with a computer-related system (e.g., an embedded system such as a modem) or method. In this context of this document, a computer-readable medium is an electronic, magnetic, optical, semiconductor, or other physical device or means that can contain or store a computer program or data for use by or in connection with a computer-related system or method. Also, the computer program or data may be transferred to another computer-readable medium by any suitable process such as by scanning the computer-readable medium.

Thus, the computer-readable medium could be paper or other suitable medium upon which the computer program can be printed, scanned with an optical scanner, and transferred into the computer's memory or storage. It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

1. A system for providing a personalized interactive program guide (IPG) at a customer premises, the system comprising:
input logic, for receiving electronic calendar data and broadcast television programming data; and
comparison logic for providing a portion of the broadcast television programming data that corresponds to one or more times a user will be unavailable to view television.

2. The system of claim 1, further comprising an electronic device comprising a first communications interface.

3. The system of claim 2, wherein the electronic device comprises a computer, a multi-function mobile telephone, and a personal digital assistant.

4. The system of claim 2, further comprising a digital home communication terminal (DHCT) located at a customer premises, the DHCT comprising a second communications interface adapted to communicate with at least the first communications interface.

5. The system of claim 4, wherein the first communications interface communicates with the second communications interface using wireless technology.

6. The system of claim 4, wherein the first communications interface communicates with the second communications interface using wired communication technology.

7. The system of claim 2, further comprising an electronic calendar stored in the electronic device, wherein the calendar comprises information corresponding to a scheduled event, and wherein the calendar information further comprises a display on the electronic device.

8. The system of claim 7, wherein the portion of the broadcast television programming data that corresponds to one or more times a user will be unavailable to view television comprises personal programming data.

9. The system of claim 8, further comprising a first virtual button on the display, adapted to access the personal programming data.

10. The system of claim 9, wherein the first virtual button is displayed in a location corresponding with the time of the scheduled event.

11. The system of claim 9, wherein the first virtual button is adapted to access a portion of the personal programming data corresponding to user selected television program content.

12. The system of claim 9, wherein the first virtual button is adapted to access a portion of the personal programming data corresponding to user selected television program format.

13. The system of claim 9, further comprising a second virtual button, wherein the second virtual button is displayed in a location corresponding with the time of the scheduled event.

14. The system of claim 13, wherein the second virtual button is adapted to access a portion of the personal programming data corresponding to user selected television program content.

15. The system of claim 8, wherein the second virtual button is adapted to access a portion of the personal programming data corresponding to user selected television program format.

16. A system for providing a personalized interactive program guide (IPG) via a digital home communication terminal (DHCT) located at a customer premises, the system comprising:
a calendar means for receiving information relating to the time and date of a scheduled event; and
a comparing means, using the information in an IPG, for determining which television programming is scheduled for the same time as the scheduled event;
a generating means for providing a user with personal programming information corresponding to the scheduled event.

17. The system of claim 16, wherein the generating means comprises a filtering means for the user to select which of the television programming is used to provide the personal programming information.

18. The system of claim 17, further comprising a scheduling means for selectively creating a scheduling program for recording the television programming that corresponds to the time of the scheduled event.

19. The system of claim 18, wherein the calendar means resides in an electronic device.

20. The system of claim 19, wherein the electronic device comprises a computer, a multi-function mobile telephone, and a personal digital assistant.

21. The system of claim 19, wherein the electronic device comprises a first virtual button, displayed in a location corresponding to the time of the scheduled event.

22. The system of claim 21, wherein the first virtual button is adapted to access a portion of the personal programming information corresponding to user selected television program content.

23. The system of claim 21, further comprising a second virtual button, displayed in a location corresponding to the time of a scheduled event.

24. The system of claim 23, wherein the second virtual button is adapted to access a portion of the personal programming information corresponding to user selected television program content.

25. The system of claim 23, wherein the second virtual button is adapted to access a portion of the personal programming information corresponding to user selected television program format.

26. A method for providing a personalized interactive program guide (IPG) via a digital home communication terminal (DHCT) located at a customer premises, the method comprising the steps of:
receiving calendar information to determine a scheduled event;
comparing the scheduled event to IPG information; and
generating personal programming information corresponding to the scheduled event.

27. The method of claim 26, wherein the calendar information is received from a local device located at the customer premises.

28. The method of claim 27, wherein the local device is a portable electronic device.

29. The method of claim 27, wherein the local device comprises a computer, a multi-function mobile telephone, and a personal digital assistant (PDA).

30. The method of claim 27, wherein the calendar information is received via wireless communication.

31. The method of claim 27, wherein the calendar information is received via a wired communication.

32. The method of claim 26, wherein the DHCT is a television settop terminal.

33. The method of claim 26, wherein the personal programming information accessed when a user selects an displayed event schedule symbol.

34. The method of claim 33, wherein the event schedule symbol is accessible via an IPG screen.

35. The method of claim 26, wherein the event schedule symbol is accessible via a service portal.

36. The method of claim 26, wherein the personal programming information comprises a displayed filter symbol for applying a filter to the personal programming information.

37. The method of claim 36, wherein the filter comprises a program content based filter.

38. The method of claim 36, wherein the filter comprises a program format based filter.

39. The method of claim 26, wherein the personal programming information comprises providing a distinctive background color in the IPG corresponding to the scheduled event.

40. The method of claim 26, further comprising transmitting the personal programming information to a local device.

41. The method of claim 40, wherein the local device is a portable electronic device.

42. The method of claim 41, wherein the local device comprises a computer, a multi-function mobile telephone, and a personal digital assistant (PDA).

43. The method of claim 41, wherein the personal programming information is accessible via a programming guide symbol displayed on the local device.

44. The method of claim 43, wherein the programming guide symbol displayed on the local device corresponds to an event displayed in a timeslot of an electronic calendar.

45. The method of claim 44, wherein the timeslot is a day when the electronic calendar view comprises multiple days.

46. The method of claim 44, wherein the timeslot is one hour when the electronic calendar view comprises one day.

47. The method of claim 44, wherein the timeslot is less than one hour when the electronic calendar view comprises one day.

48. The method of claim 40, wherein the personal programming information comprises a displayed filter symbol, for applying a filter to the personal programming data.

49. The method of claim 48, wherein a filter criteria comprises program content.

50. The method of claim 48, wherein a filter criteria comprises program format.

51. The method of claim 26, wherein the personal programming information comprises:
a channel number;
event time information; and
a program title.

52. The method of claim 51, wherein the personal programming information further comprises a program description.

53. The method of claim 51, wherein the personal programming information further comprises program duration information.

54. The method of claim 51, wherein the personal programming information further comprises accessibility to a next event sequence via a displayed next event symbol.

55. The method of claim 26, further comprising the step of scheduling a television program to be recorded during the scheduled event.

56. The method of claim 55, wherein the scheduling comprises communicating television program data to a recording device.

57. The method of claim 56, the television program data comprising:
start time;
stop time; and
channel.

58. The method of claim 55, wherein the scheduling comprises communicating television program data to an interface to a recording device.

59. The method of claim 58, the television program data comprising:
start time;
stop time; and
channel.
